(19) United States
(12) Patent Application Publication
(10) Pub. No.: US 2011/0186305 A1
(43) Pub. Date: Aug. 4, 2011

(54) GAS-BLANKETED PIPING CONNECTIONS

(75) Inventor: Glenn WILDE, Calgary (CA)

(73) Assignee: OPTIMUM PRODUCTION TECHNOLOGIES INC., Calgary (CA)

(21) Appl. No.: 12/696,943

(22) Filed: Jan. 29, 2010

(51) Int. Cl. E21B 19/16; F16L 23/00

(52) U.S. Cl. 166/380; 285/368

(57) ABSTRACT

Migration of air through a flanged connection into piping containing a gas under negative pressure is prevented by disposing concentric inner and outer gaskets between the flange faces, so as to form an annular chamber into which a blanketing gas is introduced at a pressure higher than atmospheric. Air tending to migrate through the outer gasket is blocked by the higher-pressure blanketing gas in the annular chamber. The blanketing gas pressure is maintained at a level higher than atmospheric notwithstanding any fugitive emissions through the outer gasket. The annular chambers of multiple flanged connections may be interconnected to blanket multiple flanged connections using a single source of blanketing gas. The blanketing gas may be the same type as the gas under negative pressure. In sour service applications, an inert blanketing gas may be used to prevent leakage of sour gas to atmosphere through flanged connections. In alternative embodiments, the principles of the invention may be adapted for use with other types of connections including threaded piping connections, and for use with piping carrying liquids.

### FIELD OF THE INVENTION

The present invention relates to methods and apparatus for protecting against the influx of air into piping carrying a combustible gas under negative pressure, and particularly to such methods and apparatus for protecting against such influx of air at flanged and threaded piping connections.

### BACKGROUND OF THE INVENTION

Natural gas is commonly found in subsurface geological formations such as deposits of granular material (e.g., sand or gravel) or porous rock. Production of natural gas from these types of formations typically involves drilling a well a desired depth into the formation, installing a casing in the wellbore (to keep the well bore from sloughing and collapsing), perforating the casing in the production zone (i.e., the portion of the well that penetrates the gas-bearing formation) so that gas can flow into the casing, and installing a string of tubing inside the casing down to the production zone. Gas can then be made to flow up to the surface through a production chamber, which may be either the tubing or the annulus between the tubing and the casing. The gas flowing up the production chamber is conveyed through an intake pipeline running from the wellhead to the suction inlet of a wellhead compressor. The compressed gas discharged from the compressor is then conveyed through another pipeline to a gas processing facility and sales facility as appropriate.

When natural gas is flowing up a well, formation liquids will tend to be entrained in the gas stream, in the form of small droplets. As long as the gas is flowing upward at or above a critical velocity (the value of which depends on various well-specific factors), the droplets will be lifted along with the gas to the wellhead. In this situation, the gas velocity provides the means for lifting the liquids, and the well is said to be producing by “velocity-induced flow”. Because liquids in the gas stream can cause internal damage to most gas compressors, a gas-liquid separator is provided in the intake pipeline to remove liquids from the gas stream before entering the compressor. The liquids may be pumped from the separator and reintroduced into the gas flow at a point downstream of the compressor, for eventual separation at the gas processing facility. Much more commonly, however, the liquids are collected in a tank on the well site.

In order to optimize total volumes and rates of gas recovery from a gas reservoir, the bottomhole flowing pressure should be kept as low as possible. The theoretically ideal case would be to have a negative bottomhole flowing pressure so as to facilitate 100% gas recovery from the reservoir, resulting in a final reservoir pressure of zero. In order to reduce the bottomhole pressure to a negative value, or to a very low positive value, it would be necessary to have a negative flowing pressure (i.e., lower than atmospheric pressure) in the intake pipeline. This can be readily accomplished using well-known technology, such as by providing a wellhead compressor of sufficient power.

However, negative pressure in a natural gas pipeline would present an inherent problem, because any leak in the line (such as at pipeline joints) would allow the entry of air into the pipeline, because air would naturally flow to the area of lower pressure. This would create a risk of explosion should the air/gas mixture be exposed to a source of ignition. In addition to the explosion risk, entry of air into the pipeline also creates or increases the risk of corrosion inside the pipeline. For these reasons, the pressure in the intake pipeline is typically maintained at a positive level (i.e., higher than atmospheric). Therefore, in the event of a leak in the intake pipeline, gas in the pipeline will escape into the atmosphere, rather than air entering the pipeline. The explosion and corrosion risks are thus minimized or eliminated, but in a way that effectively limits ultimate recovery of as reserves from the well.

One way of minimizing or eliminating explosion and corrosion risks, while facilitating the use of negative pressures in the intake pipeline, would be to provide an oxygen sensor in association with the pipeline. The oxygen sensor would be adapted to detect the presence of oxygen inside the pipeline, and to shut down the compressor immediately upon detection of oxygen. This system thus would more safely facilitate the use of compressor suction to induce negative pressures in the intake pipeline and, therefore, to induce negative or low positive bottomhole flowing pressures. However, this system has an inherent drawback in that its effectiveness would rely on the proper functioning of the oxygen sensor. If the sensor malfunctions, and if the malfunction is not detected and remedied in timely fashion, the risk of explosion and/or corrosion will become manifest once again. This fact highlights an even more significant drawback in that this system would not prevent the influx of air into the pipeline in the first place, but is merely directed to mitigation in the event of that undesirable event.

Canadian Patent No. 2,536,496 (Wilde) and corresponding U.S. Pat. No. 7,275,599 teach methods and apparatus for minimizing and protecting against the risk of explosion arising from the influx of air into a pipeline carrying a combustible gas under negative pressure, without relying on oxygen sensors or other devices that are prone to malfunction. In accordance with the teachings of CA 2,536,496 and U.S. Pat. No. 7,275,599, the intake pipeline running between the production chamber of a natural gas well and the suction inlet of an associated wellhead compressor is completely enclosed within a vapour-tight jacket containing natural gas under positive pressure (i.e., higher than atmospheric). The intake pipeline is thus “blanketed” by natural gas under positive pressure and thus not exposed to the atmosphere. This arrangement allows gas to be drawn into the compressor through the intake pipeline under a negative pressure, without risk of air entering the intake pipeline should a leak occur in the pipeline. Should such a leak occur, there would merely be a harmless transfer of gas from the positive pressure jacket into the intake pipeline. Should a leak develop in the positive pressure jacket, any gas leaking therefrom would escape into the atmosphere, and entry of air into the positive pressure jacket would be impossible. System components other than piping, such as compressors and separators, may be similarly enclosed within a positive pressure gas jacket in accordance with CA 2,536,496 and U.S. Pat. No. 7,275,599.

Although the methods and apparatus taught by CA 2,536,496 and U.S. Pat. No. 7,275,599 have proved highly effective in actual use, it may be desirable in certain situations to provide protection against air influx into piping and equipment components containing gas under negative pressure without complete enclosure in a positive pressure gas jacket. For example, in absence of material defects, the risk of air influx through the walls of pressure-rated piping and vessels will typically be far less than the potential risk of air influx at bolted flanged connections between piping sections, or where piping sections connect to pressure vessels. If effective protection against air influx can be provided at flanged connections, it may be unnecessary to provide complete or even partial positive pressure gas jacketing.

Bolted flanged connections typically use gaskets to prevent leakage through the connection. However, there are no perfect or foolproof gaskets, and fugitive emissions of gas through gasketed flanged connections are a common reality. Such fugitive emissions are typically small in terms of volume or rate of gas leakage, and therefore do not pose a safety hazard in situations where the piping involved is carrying gas at a pressure higher than atmospheric, because any gas leakage through the gaskets will be to atmosphere. This might not be desirable from an environmental standpoint, but it does not create a fire or explosion hazard.

The situation is different in the case of a flammable gas under partial vacuum. In this situation, deficiencies or defects in the gaskets can result in the higher-pressure air leaking into the stream of flowing gas (or into non-flowing gas in a storage vessel), thereby causing a serious hazard even when only small volumes of air are involved. For this reason, gasketing technology per se cannot be relied on to provide an acceptable solution to the problem of air leakage through bolted flanged connections into conduits or vessels containing flammable gas under negative pressure.

For these reasons, there is a need for apparatus and methods for protecting against influx of air through flanged and other types of piping connections into piping and vessels carrying gas under negative pressure. As well, there is a need for apparatus and methods for providing improved or enhanced protection against the escape of harmful or hazardous gases (such as but not limited to “sour” gas) from flanged and other types of piping connections The present invention is directed to these needs.

### BRIEF DESCRIPTION OF THE INVENTION

In general terms, the present invention provides methods and apparatus for preventing migration of either gaseous or liquid fluids through a piping connection, from a region of higher pressure to a region of lower pressure. In many if not most practical applications, the invention will be used to prevent migration of a gas through a piping connection, and the invention is described and illustrated in that context in this patent document. It is to be understood, however, that the methods and apparatus of the invention can also be adapted for applications intended to prevent migration of liquids through a piping connection.

In accordance with one embodiment of the present invention, the inward migration of air through a bolted flanged connection, and into a vessel or piping containing a flammable gas under negative pressure, may be prevented by providing double seal means between the mating faces of the two flanges being connected, with the double seal means being configured to form an annular chamber into which a blanketing gas is introduced, at a pressure higher than atmospheric.

In a preferred embodiment, the double seal means comprises a pair of generally concentric, spaced-apart inner and outer ring-shaped gaskets (the term “ring-shaped” in this context not to be construed as restricted to circular rings, but inclusive of rings of other configurations). The annular chamber is thus defined by the flange faces, the outer edge of the inner gasket, and the inner edge of the outer gasket. However, the double seal means could take other forms without departing from the principles and scope of this embodiment of the invention. When gaskets are used, they do not necessarily have to be made of resilient materials commonly used for many types of gaskets; for example, solid metal ring gaskets could be used in appropriate applications. In other variants, the double seal means could be in the form of a unitary double-sealing gasket that has an annular recess formed into one face, such that the recess defines the required annular chamber when the unitary double-sealing gasket is clamped between the two flange faces. What is important is for the double seal means to provide an inner seal and an outer seal against the flange faces, with the inner and outer seals being spaced so as to form an annular chamber.

The blanketing gas is introduced into the annular chamber through a gas inlet channel drilled or otherwise formed in one of the flanges. The other flange may be provided with a similar gas outlet channel, from which blanketing gas can flow to another blanketed flanged connection (and so on), to facilitate positive-pressure gas blanketing of multiple flanged connections using a single source of blanketing gas.

Any air that might for any reason tend to migrate inward through the outer gasket will be at a lower pressure than the blanketing gas, which will thus block the air from migrating further inward toward the vessel or piping. The blanketing gas pressure is maintained at a level sufficient to ensure that it remains higher than atmospheric notwithstanding any fugitive emissions of blanketing gas inward through the inner gasket or outward through the outer gasket. Suitable pressure gauges and gas valves will preferably be provided in association with each blanketed flange (or each group of blanketed flanges served by a common blanketing gas source), to facilitate monitoring and regulation of the blanketing gas pressure.

The blanketing gas may be the same type of gas as the gas under negative pressure, as will commonly be convenient when using blanketed flange assemblies in association with natural gas production facilities. As an alternative, the blanketing gas may be an inert gas, such as nitrogen (by way of non-limiting example).

In alternative embodiments, the present invention provides methods and apparatus for preventing migration of gas (or liquid) through non-flanged piping connections (threaded or unthreaded) from a region of higher pressure to a region of lower pressure. For example, in an NPT piping connection (i.e., a connection using tapered threads in accordance with the U.S. National Pipe Thread standard), the engagement between the internal (female) threads of a first pipe and the external (male) threads of a second pipe can provide a primary circumferential seal. The first pipe end may be provided with an unthreaded and at least substantially cylindrical extension section extending beyond the internally-threaded section, such that in the assembled connection, the extension section of the first pipe end extends over an unthreaded region of the outer surface of the second pipe end (also referred to herein as a cylindrical interface region). A secondary circumferential seal is provided in the cylindrical interface region, and a circumferential annular chamber is formed either in the inner cylindrical wall of the extension section of the first pipe or in the interface region of the second pipe, with the circumferential annular chamber being disposed between the secondary circumferential seal and the primary seal formed by the engagement of the tapered male and female threads.

The circumferential annular chamber is in fluid communication with a source of positive-pressure blanketing gas (i.e., at a pressure higher than that of a process gas flowing through the first and second pipes). Accordingly, any tendency of the process gas to migrate outward through the primary circumferential seal (e.g., the threaded connection) will be prevented by the higher-pressure blanketing gas. The blanketing gas in this application will preferably be an inert gas such as nitrogen, such that any leakage of blanketing gas through the secondary circumferential seal will be environmentally, benign. This embodiment is particularly advantageous and beneficial for applications where the process gas is sour gas.

For threaded piping connections having untapered threads (e.g., machine threads) by providing primary and secondary circumferential seals in the form of O-rings or other suitable known seal means, with a circumferential annular chamber being provided or formed between the primary and secondary seals. The position of the seals relative to the engaged threads is not critical; for example, there could be one seal on each side of the threads, or both seals could be provided on one side of the engaged threads.

The same general principle may also be applied in the context of non-threaded piping connections.

The principles of the present invention may be readily applied for purposes other than preventing migration of air into a vessel or piping carrying gas under negative pressure. For example, in the production of “sour gas” (i.e., natural gas containing significant amounts of hydrogen sulphide), a primary concern is to prevent migration of sour gas from production piping and equipment into the atmosphere. In conventional gasketed flanged connections, there is a risk of fugitive sour gas emissions to atmosphere when the sour gas in the vessel or piping is at or higher than surrounding atmospheric pressure. Gas-blanketed piping and equipment flanges, in accordance with the present invention, may be used to prevent such fugitive emissions. In this application, an inert blanketing gas such as nitrogen is introduced into the annular chamber of each flanged connection, at a pressure higher than the pressure of the sour gas in the vessel or piping. The inert blanketing gas thus blocks any outward migration of sour gas past the inner gasket of the blanketed flange assembly. The blanketing gas pressure is maintained at a level sufficient to ensure that it remains higher than atmospheric notwithstanding any fugitive emissions of blanketing gas outward through the outer gasket.

Accordingly, in a first aspect the present invention provides a piping connection assembly comprising a first pipe having a first end; a second pipe having a first end; a first annular flange mounted to the first end of the first pipe, said first flange having an annular connection face; a second annular flange mounted to the first end of the second pipe, said second flange having an annular connection face; connection means for connecting the first and second flanges with their connection faces in juxtaposition; and double seal means disposed between the two flange connection faces and configured to form an annular chamber. A gas inlet channel extends through a selected one of the flanges so as to be in fluid communication with the annular chamber, such that a gas flowing into the gas inlet channel will flow into the annular chamber.

In a second aspect, the present invention provides a piping connection assembly comprising a first pipe having a female end, and a second pipe having a male end; connection means for connecting said female end of the first pipe and said male end of the second pipe; primary seal means extending around the circumference of the male end of the second pipe, said primary seal means providing a seal between the first and second pipes; secondary seal means extending around the circumference of the male end of the second pipe, said secondary seal being axially spaced from the primary seal and providing a seal between the first and second pipes; an annular chamber extending around the circumference of the male end of the second pipe, said annular chamber being disposed between the primary and secondary seals; and a gas inlet channel extending through the wall of a selected one of the first and second pipes so as to be in fluid communication with the annular chamber, such that a gas flowing into the gas inlet channel will flow into the annular chamber.

In a third aspect, the present invention teaches a method of providing enhanced protection against migration of gas through a connection between two fluid-carrying pipes, said method comprising the steps of providing primary and secondary seals extending around the connection, said primary and secondary seals being spaced apart, and each of said primary and secondary seal means providing a seal between the first and second pipes; providing an annular chamber extending around the circumference of the male end of the second pipe, said annular chamber being disposed between the primary and secondary seals; and providing a gas inlet channel in fluid communication with the annular chamber and with a source of a blanketing gas, such that blanketing gas can flow through the gas inlet channel into the annular chamber.

### BRIEF DESCRIPTION OF THE DRAWINGS

Embodiments of the invention will now be described with reference to the accompanying figures, in which numerical references denote like parts, and in which:

FIG. 1 is a schematic diagram of a natural gas wellhead and associated piping and equipment components, enclosed within a positive pressure gas jacket in accordance with prior art technology.

FIG. 2 is cross-sectional detail through a bolted flanged piping connection with positive pressure gas blanketing in accordance with a first embodiment of the present invention.

FIG. 3 is a cross-section through a wellhead assembly with gas-blanketed flanges in accordance with a second embodiment of the present invention, with the wellhead assembly incorporating a gas-blanketed shut-off valve.

FIG. 4 is a cross-section through a generic non-flanged connection between two piping sections, with gas blanketing in accordance with a third embodiment of the present invention.

FIG. 5 is a cross-section through a taper-threaded connection between two piping sections, with gas blanketing in accordance with a fourth embodiment of the present invention.

### DETAILED DESCRIPTION OF THE PREFERRED EMBODIMENT

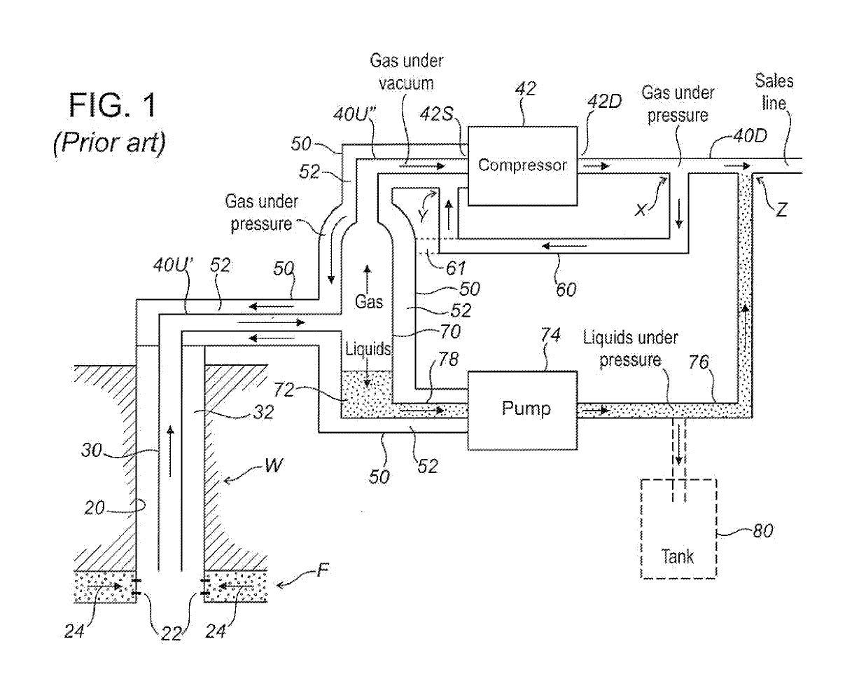

The present invention will be best understood after first reviewing methods and apparatus taught by CA 2,536,496 and U.S. Pat. No. 7,275,599 for protecting against air influx into piping and equipment components conveying or containing gas under negative pressure. FIG. 1 (which is not to scale) schematically illustrates a typical natural gas well W penetrating a subsurface formation F containing natural gas. Well W is lined with a casing 20 which has a number of perforations conceptually illustrated by short lines 22 within a production zone (generally corresponding to the portion of the well penetrating the formation F). As conceptually indicated by arrows 24, formation fluids including gas, oil, and water may flow into the well through the perforations 22. A string of tubing 30 extends inside the casing 20, terminating at a point within the production zone. The bottom end of the tubing 30 is open such that fluids in the wellbore may freely enter the tubing 30. An annulus 32 is formed between the tubing 30 and the casing 20. The upper end of the tubing 30 runs into a surface termination apparatus or “wellhead.” (not illustrated), of which various types are known in the field of gas wells.

Tubing 30 serves as a production chamber to carry gas from well W to a production pipeline 40 having an upstream section 40U which carries the gas through a gas-liquid separator 70 to the suction manifold 42S of a gas compressor 42. Separator 70 divides the upstream pipeline into section 40U′ on the wellhead side of separator 70, and section 40U″ on the compressor side of separator 70. Production pipeline 40 also has a downstream section 40D which connects at one end to the discharge manifold 42D of compressor 42 and continues therefrom to a gas processing facility (not shown). As schematically indicated, liquids 72 separated from the gas flowing through intake pipeline 40U′ will accumulate in a lower section of separator 70. In the usual case, liquids 72 flow from separator 70 to a storage tank 80 on the well site.

The apparatus shown in FIG. 1 provides for production of gas under negative pressure, in which case liquids 72 removed from the gas stream by separator 70 will also be under negative pressure, and for this reason a vacuum pump 74 is provided as shown. Liquids 72 flow under negative pressure through a pump inlet line 78 to pump 74, which pumps liquids 72, now under positive pressure, through a liquid return line 76 into downstream section 40D of production pipeline 40 at a point Z downstream of compressor 42. Alternatively, liquids 72 may be pumped to an on-site storage tank 80.

As illustrated in FIG. 1, upstream pipeline sections 40U′ and 40U″, separator 70, and pump inlet line 78 are fully enclosed by a vapour-tight positive pressure jacket 50 that defines a continuous internal chamber 52. A gas recirculation pipeline 60 extends between, and is in fluid communication with, downstream section 40D of production pipeline 40 (at point X located between compressor 42 and point Z) and a selected pressure connection point Y on positive pressure jacket 50. As shown in FIG. 1, pressure connection point Y may be located in upstream pipeline section 40U″ between compressor 42 and separator 70. By means of recirculation pipeline 60, a portion of the gas discharged from discharge manifold 42D of compressor 42 may be diverted into positive pressure jacket 50, such that upstream pipeline sections 40U′ and 40U″, separator 70, and pump inlet line 78 are entirely enclosed by a “blanket” of gas under positive pressure. Positive pressure jacket 50 thus enshrouds all components of the apparatus containing combustible fluids under negative pressure between the wellhead and suction manifold 42S of compressor 42 with a blanket of gas under positive pressure, thereby preventing the entry of air into the combustible fluids present in any of those components.

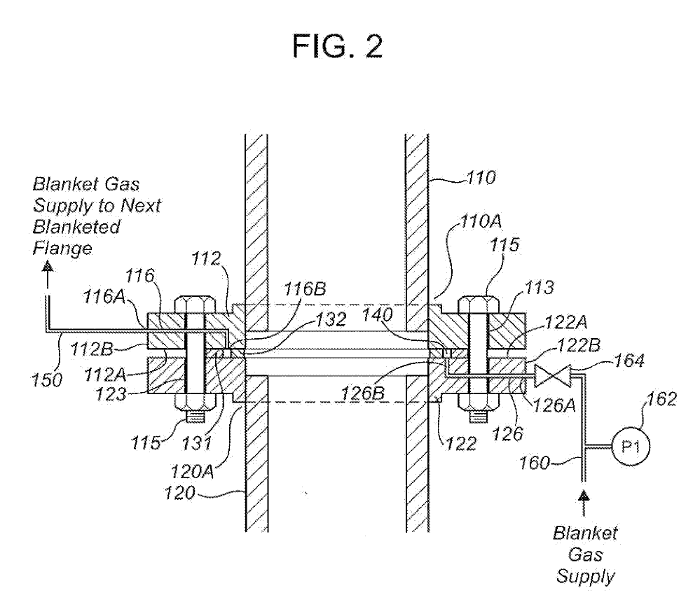

Turning now to the present invention, FIG. 2 illustrates a gas-blanketed flanged piping connection in accordance with one embodiment of the invention. A first end 110A of a first pipe 110 is fitted with an annular flange 112, which has a planar annular end face 112A and bolt holes 113. A first end 120A a second pipe 120 is fitted with an annular flange 122, which has a planar annular end face 122A and bolt holes 123 configured to match bolt holes 113 in annular flange 112. An annular outer gasket 131 is positioned on (and preferably bonded to) either end face 112A of flange 112 or end face 122A of flange 122, with outer gasket 131 being sized such that outer gasket 131 is entirely disposed radially inward of bolt holes 113. An annular inner gasket 132 is positioned on (and preferably bonded to) either end face 112A of flange 112 or end face 122A of flange 122, with inner gasket 132 being sized such that outer gasket 131 is entirely disposed radially inward of outer gasket 13.1, such that when flanges 112 and 122 are bolted together using bolts 115 as shown in FIG. 2, a continuous annular space 140 is formed between outer gasket 131 and inner gasket 132.

A gas outlet channel 116 is drilled or otherwise formed in flange 112 on first pipe 110, with gas outlet channel 116 extending between a first end 116A and a second end 116B. First end 116A of gas outlet channel 116 is located at a selected point on flange 112 other than end face 112A thereof, and is adapted for connection with a gas outlet conduit 150. Second end 116B of gas outlet channel 116 is in fluid communication with annular space 140. In preferred embodiments, and as shown in FIG. 2, first end 116A of gas outlet channel 116 is located on the outer perimeter face 112B of flange 112.

A gas inlet channel 126 is drilled or otherwise formed in flange 122 on second pipe 120, with gas inlet channel 126 extending between a first end 126A and a second end 126B. First end 126A of gas inlet channel 126 is located at a selected point on flange 122 other than end face 122A thereof, and is adapted for connection with a gas inlet conduit 160. Second end 126B of gas inlet channel 126 is in fluid communication with annular space 140, preferably but not necessarily at a point diametrically opposite from second end 116B of gas outlet channel 116. In preferred embodiments, and as shown in FIG. 2, first end 126A of gas inlet channel 126 is located on the outer perimeter face 12213 of flange 122, but this is by way of example only; gas inlet channel 126 can be located and routed in a variety of ways without departing from the concept of the present invention. A pressure gauge 162 is installed in conjunction with gas inlet conduit 160, and a valve 164 is installed in gas inlet conduit 160 at a point between first end 126A of gas inlet channel 126 (at flange 122) and pressure gauge 162.

To put the embodiment of FIG. 2 into practice, flanges 112 and 122 are bolted together as shown, with gaskets 131 and 132 being sufficiently compressed to form substantially vapour-tight seals against both end face 112A of flange 112 and end face 122A of flange 122. A flow of a “blanketing” gas is introduced into gas inlet conduit 160, whereupon opening valve 164 will cause the blanketing gas to flow into annular chamber 140 between gaskets 131 and 132. The blanketing gas exits annular chamber 140 via gas outlet channel 116 and gas outlet conduit 150, which may be connected to another gas-blanketed flange assembly (preferably with its own valve and pressure gauge).

The blanketing gas pressure is maintained at a level higher than atmospheric pressure, thus protecting the connection against influx of air into pipes 110 and 120 when carrying a flammable gas under negative pressure. The blanketing gas pressure may be monitored by means of pressure gauge 162. For installations having multiple gas-blanketed flange assemblies, a leak in the gas-blanketing system will be detectable from discrepancies between readings of the pressure gauges 162 associated with the various flange assemblies. In such event, one or more of valves 164 associated with the flange assemblies can be closed as required to isolate each flange assembly in turn, in order to pinpoint the source of the leak.

In an alternative embodiment, a pressure switch (not shown) can be used in association with an assembly of multiple gas-blanketed flange assemblies served by a common source of blanketing gas. The pressure switch is programmed to automatically shut off the flow of gas within the piping if the pressure of the blanketing gas drops below a preset value.

In the embodiment shown in FIG. 2, gas outlet channel 116 is formed in one flange (flange 112), and gas inlet channel 126 is formed in the other flange (flange 122). However, this is by way of example only, and persons skilled in the art will appreciate that gas outlet channel 116 and gas inlet channel 126 may be formed in either flange without departing from the principles and scope of the present invention. Moreover, it is not necessary for gas outlet channel 116 to be formed in one flange and for gas inlet channel 126 to be formed in the other flange; in alternative embodiments, both gas outlet channel 116 and gas inlet channel 126 may be formed in a selected one of the flanges.

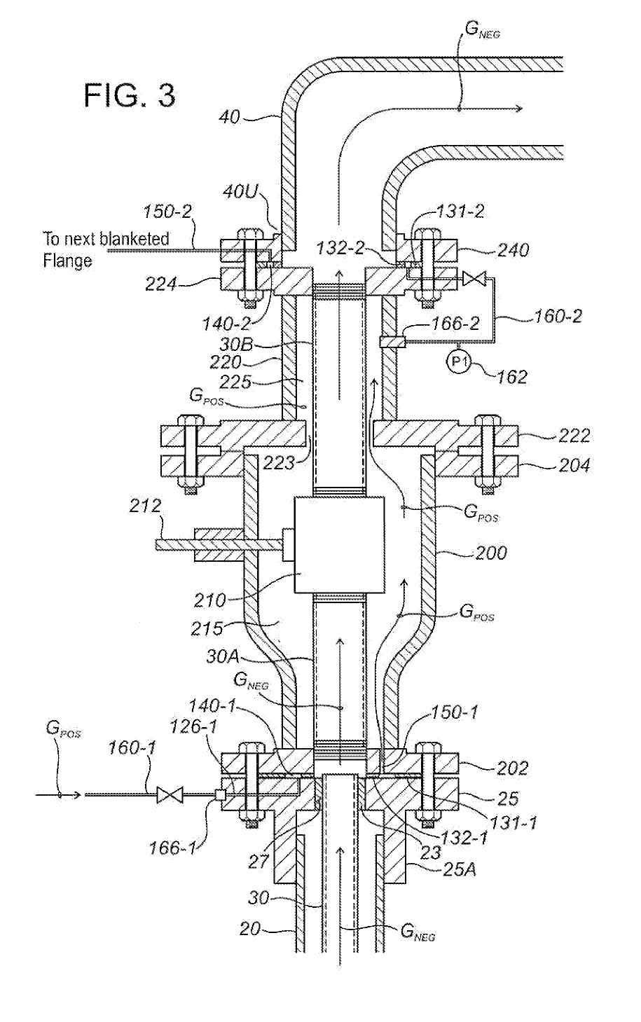

FIG. 3 provides just one example of how the principles of the present invention can be adapted to a variety of practical situations. FIG. 3 conceptually illustrates an assembly associated with the wellhead of a well producing natural gas under negative pressure generally as shown in FIG. 1. Natural gas G_{NEG} under negative pressure flows upward through production tubing 30 disposed within well casing 20. The upper ends of casing 20 and tubing 30 terminate at a wellhead flange 25, with the open upper end of tubing 30 being supported by a conventional tubing hanger (not shown) and sealingly disposed, in conjunction with annular packing means 23, in an opening 27 in wellhead flange 25. In the embodiment shown in FIG. 3, wellhead flange 25 has a downwardly extending collar 25A which receives casing 20.

A valve housing 200 (formed in the illustrated embodiment from two pieces of pipe of different diameters with a swedge transition) has a lower end welded to a lower valve housing flange 202, which is bolted to wellhead flange 25. The upper end of valve housing 200 is welded to an annular upper valve housing flange 204. A first extension tube 30A has a lower end threaded into an opening in lower valve housing flange 202, and an upper end connected to a shut-off valve 210 disposed within valve housing 200 (with valve stem 212 extending through the wall of valve housing 200). A second extension tube 30B has a lower end connected to shut-off valve 210. A housing annulus 215 is thus formed between extension tubes 30A and 30B and shut-off valve 210, and the inner wall surface of valve housing 200.

A pipe stub 220 has a lower end welded to a flange 222, which is bolted to upper valve housing flange 204. Flange 222 has an opening 223 through which second extension tube 30B upwardly extends and forms an upper annulus 225 between second extension tube 30B and the inner wall surface of pipe stub 220. The upper end of second extension tube 30B is connected to an upper stub flange 224. Upper annulus 225 is in fluid communication with valve housing annulus 215 through opening 223, which is of larger diameter than second extension tube 30B. A production pipeline 40 has an upstream end 40U connected to an annular flange 240, which is bolted to upper stub flange 224.

The connection between wellhead flange 25 and lower valve housing flange 202 is a gas-blanketed assembly generally as shown in FIG. 2. A first inlet gas conduit 160-1 connects, via a first fitting 166-1 in the perimeter of wellhead flange 25, to a first gas inlet channel 126-1 which leads to a first annular space 140-1 formed between flanges 25 and 202 and spaced concentric gaskets 131-1 and 132-1. A first outlet gas channel 150-1 extends through lower valve housing flange 202 so as to be in fluid communication with first annular space 140-1 and valve housing annulus 215. Positive-pressure gas G_{POS} flows through gas inlet channel 126-1 into first annular space 140-1 and thence through first outlet gas channel 150-1 into valve housing annulus 215 and thence into upper annulus 225 through opening 223 in flange 222, thus providing positive pressure gas blanketing to extension tubes 30A and 30B and shut-off valve 210, through which flows negative-pressure gas G_{NEG}.

The connection between flanges 224 and 240 is a gas-blanketed assembly generally as in FIG. 2. Positive-pressure blanketing gas G_{POS} is supplied to this assembly through a second gas inlet conduit 160-2 leading from upper annulus 225 (via a second fitting 166-2 through the wall of pipe stub 220) to a second annular space 140-2 formed between flanges 224 and 240 and spaced concentric gaskets 131-2 and 132-2. A second outlet gas channel 150-2 extends from second annular space 140-2 through flange 202 for connection to another gas-blanketed connection served by the same source of blanketing gas.

The connection between flanges 204 and 222 does not require positive pressure gas blanketing, as it is not exposed to negative-pressure gas G_{NEG}.

The use and operation of gas-blanketed flanges in accordance with the present invention may be readily understood with reference to the Figures and the preceding description. In installations where multiple flanged connections are to be blanketed, each such connection would be generally as shown in FIG. 2. Blanketing gas from a suitable source flows through gas inlet conduit 160 and gas inlet channel 126 into annular chamber 140, from which the blanketing gas exits through gas outlet channel 116 and gas outlet conduit 150, with gas outlet conduit 150 serving as the gas inlet conduit for purposes of another blanketed flange, and so on.

In preferred usage, the pressure of the blanketing gas will be monitored and regulated by means of pressure gauge 162 used in conjunction with valve 164, thereby facilitating detection of any pressure drops necessitating an increase in the blanketing gas inlet pressure. A single pressure gauge 162 in conjunction with a single valve 164 can be used in association with a system of multiple blanketed flanges served by a common source of blanketing gas. However, it is preferable to provide a pressure gauge 162 and a valve 164 in association with each blanketed flange assembly to facilitate temporary isolation of individual flange assemblies, which will be beneficial for purposes of locating any leaks in the blanketing gas system.

Typically, there will be little or no flow of blanketing gas through the gas inlet and outlet conduits once blanketing gas has been initially delivered to the annular chambers of all gas-blanketed flanges in the system. In alternative embodiments, however, blanketing gas could be circulated through the system of gas-blanketed flanges.

In simple situations where it is necessary or desirable to provide gas blanketing to a single flanged connection only, the assembly would be generally as shown in FIG. 2, except that there would be no need for gas outlet channel 116 and gas outlet conduit 150.

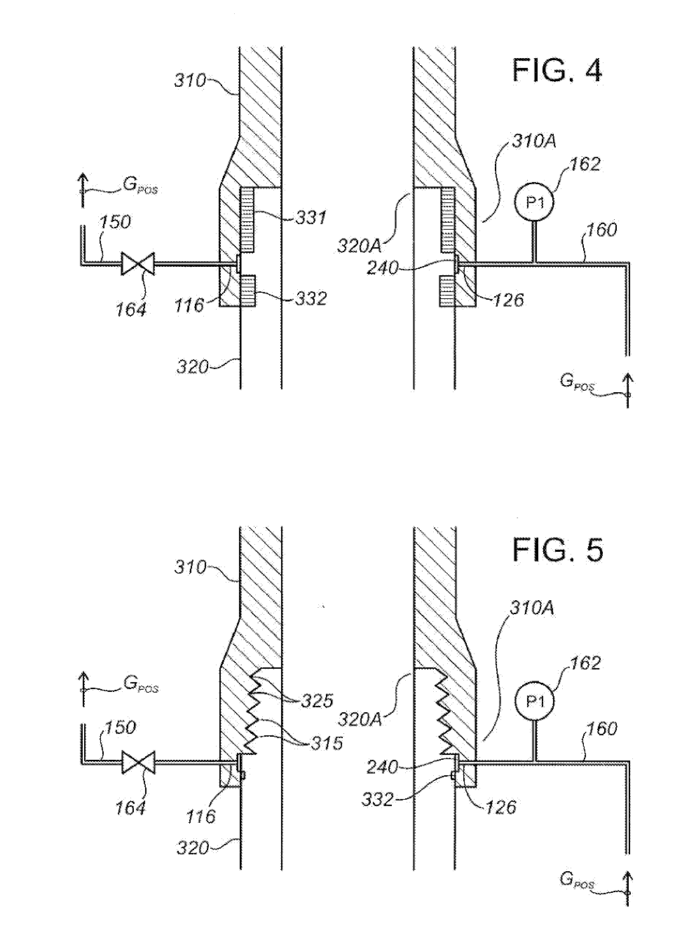

FIGS. 4 and 5 illustrate embodiments of the present invention for use with non-flanged piping connections. In the general case shown in FIG. 4, a first pipe 310 has a female end 310A adapted for connection with a male end 320A of a second pipe 320 by suitable connection means, in conjunction with longitudinally-spaced primary and secondary circumferential seals 331 and 332. In the assembled connection, first circumferential seal 331 is proximal to the end of second pipe 320 and secondary circumferential seal 332 is proximal to the end of first pipe 310. A circumferential annular chamber 240 is formed in a region between primary and secondary circumferential seals 331 and 332, in either first pipe 310 or second pipe 320 (or, alternatively, formed partially in each of first and second pipes 310 and 320).

Circumferential annular chamber 240 is in fluid communication with a source of positive-pressure blanketing gas by means of a gas inlet conduit 160 and a gas inlet channel 126 extending through the wall of first pipe 310. A gas outlet channel 116 preferably extends through the wall of first pipe 310 at a location diametrically opposite from gas inlet channel 126, for connection to a gas outlet conduit 150 which carries blanketing gas to another piping connection in a multiple blanketed-flange system. As in the embodiments shown in FIGS. 2 and 3, a pressure gauge 162 and a gas valve 164 are preferably provided in association with either gas inlet conduit 160 or gas outlet conduit 150.

FIG. 5 illustrates a particular embodiment of the general case of FIG. 4, in which first second pipes 310 and 320 have tapered NPT threads. In this embodiment, primary circumferential seal 331 takes the form of the engagement between tapered female threads 315 of first pipe 310 and tapered male threads 325 of second pipe 320, with tapered threads 315 and 316 also serving, as the means for connecting first second pipes 310 and 320. Secondary circumferential seal 332 is provided in the form of an O-ring disposed within a circumferential groove in second pipe 320. However, persons skilled in the art will readily appreciate that secondary circumferential seal 332 can take a variety of other forms in accordance with known sealing technologies.

In piping connections configured as in FIGS. 4 and 5, any tendency of a gas flowing within first and second pipes 310 and 320 to migrate outward through primary circumferential seal 331 (e.g., the threaded connection of FIG. 5) will be counteracted by the higher-pressure blanketing gas G_{POS} introduced into circumferential annular chamber 240. Blanketing gas G_{POS} in such practical applications will preferably be an inert gas such as nitrogen, so that any leakage of blanketing gas G_{POS} through secondary circumferential seal 332 will be environmentally benign.

Persons skilled in the art will readily appreciate that the concept and principles of the present invention will be operative in any assembly in which there is a mechanical connection of some type between two gas-containing sections of pipe, with associated primary and secondary seals configured to create a annular chamber disposed between the primary and secondary seals, plus means for introducing a blanketing gas into the annular chamber. The particular embodiments described and illustrated herein (i.e., in conjunction with flanged and threaded piping connections) are specific examples of the general case, and the present invention is not restricted or limited to such exemplary embodiments.

It will be readily appreciated by those skilled in the art that various modifications of the present invention may be devised without departing from the essential concept of the invention, and all such modifications are intended to come within the scope of the present invention and the claims appended hereto. It is to be especially understood that the invention is not intended to be limited to illustrated embodiments, and that the substitution of a variant of a claimed element or feature, without any substantial resultant change in the working of the invention, will not constitute a departure from the scope of the invention.

In this patent document, any form of the word “comprise” is to be understood in its non-limiting sense to mean that any item following such word is included, but items not specifically mentioned are not excluded. A reference to an element by the indefinite article “a” does not exclude the possibility that more than one of the element is present, unless the context clearly requires that there be one and only one such element. Any use of any form of the terms “connect”, “fasten”, “engage”, “couple”, “attach”, or any other term describing an interaction between elements is not meant to limit the interaction to direct interaction between the subject elements, and may also include indirect interaction between the elements such as through secondary or intermediary structure. Relational terms such as “parallel”, “perpendicular”, “planar”, “coaxial”, “concentric”, “coincident”, “intersecting”, “equal”, and “equidistant” are not intended to denote or require absolute mathematical or geometrical precision. Accordingly, such terms are to be understood as denoting or requiring substantial precision only (e.g., “substantially parallel”) unless the context clearly requires otherwise.

What is claimed is:

1. A piping connection assembly comprising:
(a) a first pipe having a first end, and a second pipe having a first end;
(b) a first flange mounted to the first end of the first pipe, said first flange having a central opening and an annular connection face;
(c) a second flange mounted to the first end of the second pipe, said second flange having a central opening and an annular connection face;
(d) connection means for connecting said first and second flanges with their connection faces in juxtaposition;
(e) double seal means disposed between the two flange connection faces and configured to form an annular chamber; and
(f) a gas inlet channel extending through a selected one of the flanges so as to be in fluid communication with the annular chamber, such that a gas flowing into the gas inlet channel will flow into the annular chamber.

2. A piping connection assembly as in claim 1 wherein the double seal means comprises:
(a) an inner circular gasket having an outer diameter, and an inner diameter greater than the diameter of the larger of the central openings of the first and second flanges; and
(b) an outer circular gasket having an inner diameter greater than the outer diameter of the inner gasket;
wherein the inner and outer gaskets are positioned concentrically between the connection faces of the first and second flanges, thereby forming an annular chamber defined by the outer diameter of the inner gasket, the inner diameter of the outer gasket, and the connection faces of the first and second flanges.

3. A piping connection assembly as in claim 1 wherein a gas outlet channel extends through a selected one of the first and second flanges so as to be in fluid communication with the annular chamber, such that gas can exit the annular chamber through the gas outlet channel.

4. A piping connection assembly as in claim 1, further comprising a pressure switch associated with a selected one of the gas inlet channel and the gas outlet channel, said pressure switch being programmable to shut off the flow of gas to the annular chamber when the pressure of the gas drops below a preset value.

5. A piping connection assembly comprising:
(a) a first pipe having a female end, and a second pipe having a male end;
(b) connection means for connecting said female end of the first pipe and said male end of the second pipe;
(c) primary seal means extending around the circumference of the male end of the second pipe, said primary seal means providing a seal between the first and second pipes;
(d) secondary seal means extending around the circumference of the male end of the second pipe, said secondary seal being axially spaced from the primary seal and providing a seal between the first and second pipes;
(e) an annular chamber extending around the circumference of the male end of the second pipe, said annular chamber being disposed between the primary and secondary seals; and
(f) a gas inlet channel extending through the wall of a selected one of the first and second pipes so as to be in fluid communication with the annular chamber, such that a gas flowing into the gas inlet channel will flow into the annular chamber.

6. A piping connection assembly as in claim 5, further comprising a gas outlet channel extending through the wall of a selected one of the first and second pipes so as to be in fluid communication with the annular chamber, such that gas can exit flow from the annular chamber through the gas outlet channel.

7. A piping connection assembly as in claim 5, further comprising a pressure switch associated with a selected one of the gas inlet channel and the gas outlet channel, said pressure switch being programmable to shut off the flow of gas to the annular chamber when the pressure of the gas drops below a preset value.

8. A piping connection assembly as in claim 5, wherein the connection means comprises a threaded connection.

9. A piping connection assembly as in claim 8, wherein the threaded connection is a tapered-thread connection.

10. A piping connection assembly as in claim 9, wherein the tapered-thread connection serves as the primary seal means.

11. A method of providing enhanced protection against migration of fluid through a connection between two fluid-carrying pipes, said method comprising the steps of:
(a) providing primary and secondary seals extending around the connection, said primary and secondary seals being spaced apart, and each of said primary and secondary seal means providing a seal between the first and second pipes;
(b) providing an annular chamber extending around the circumference of the male end of the second pipe, said annular chamber being disposed between the primary and secondary seals; and
(c) providing a gas inlet channel in fluid communication with the annular chamber and with a source of a blanketing gas, such that blanketing gas can flow through the gas inlet channel into the annular chamber.

12. A method as in claim 11 comprising the further step of providing a gas outlet channel in fluid communication with the annular chamber, such that blanketing gas can exit flow from the annular chamber through the gas outlet channel.

13. A method as in claim 11 wherein the blanketing gas is an inert gas.

14. A method as in claim 11 wherein the connection between the two pipes is a flanged connection, with each pipe having a flange mounted thereto, and with each flange having an annular connection face, and wherein:
(a) the primary seal means comprises a circular inner gasket having an outer diameter and an inner diameter;
(b) the secondary seal means comprises a circular outer gasket having an inner diameter greater than the outer diameter of the inner gasket; and
(c) the annular chamber is defined by the outer diameter of the inner gasket, the inner diameter of the outer gasket, and the connection faces of the first and second flanges.

15. A method as in claim 11 wherein the connection between the two pipes is a threaded connection.

16. A method as in claim 15 wherein the threaded connection is a tapered-thread connection.

17. A method as in claim 16, wherein the tapered-thread connection serves as the primary seal means.
